(19) United States
(12) Patent Application Publication
(10) Pub. No.: US 2016/0085088 A1
(43) Pub. Date: Mar. 24, 2016

(54) ULTEM SPECTACLE LEG WITH LIGHT WEIGHT AND LARGE WIDTH

(71) Applicant: SUNG SAN PRECISION CO., LTD, Daegu (KR)

(72) Inventor: Jae-Yel SUH, Daegu (KR)

(73) Assignee: SUNG SAN PRECISION CO., LTD, Daegu (KR)

(21) Appl. No.: 14/785,096

(22) PCT Filed: Apr. 16, 2013
(86) PCT No.: PCT/KR2013/003162

§ 371 Date: Oct. 16, 2015

(51) Int. Cl. G02C 5/16; G02C 5/22; G02C 11/02; G02C 5/00

(52) U.S. Cl. CPC G02C 5/16; G02C 5/008; G02C 5/22; G02C 11/02; G02C 2200/16

(57) ABSTRACT

The invention relates to an Ultem spectacle leg with a light weight and a large width, and more specifically the Ultem spectacle leg (10) hinged to a spectacle frame includes wing parts (11) formed on both sides of the leg and a central support part (12), wherein the wing parts (11) formed on the upper and the lower side of the spectacle leg (10) have a thickness of 0.8 mm to 1 mm, and the support part (12) is formed lengthwise in the central part of the spectacle leg (10) with a thickness larger than the wing parts (11), so as to achieve a resilient Ultem spectacle leg with a large width and a light weight, so that the spectacles provided with the Ultem leg are lighter, highly resilient, more durable, and produce the two tonal effect caused by the support part's (12) resulting aesthetics, thus maximizing a user's personality.

### TECHNICAL FIELD

The present invention relates to a light weight and large width Ultem spectacle leg, and more particularly, to a light weight and large width Ultem spectacle leg that is made of an Ultem material and includes wing parts formed on upper and lower side end portions thereof and each having a thickness of 0.8 to 1 mm and a support part formed on the center of the spectacle leg in a longitudinal direction thereof, thus reducing the weight of the spectacle leg, increasing the durability of the spectacle leg, and providing two-tone effects when the spectacle leg is worn.

### BACKGROUND ART

Generally, a pair of spectacle legs is hinge-coupled to one side of a spectacle frame and the other side thereof, thus taking a shape of a pair of spectacles. Spectacles are generally used for the correction of a wearer's vision, but recently, since the wearer's impression is dependent upon the spectacles worn on him or her, he or she wants to have such spectacles giving a good impression to other people so as to improve his or her interpersonal relationship and love relationship and to obtain good results of his or her interview.

As modern society has been fast changed, recently, spectacles, which provide uniqueness for wearers have been shipped to satisfy the desire of the wearers, and further, many studies on such spectacles have been made to develop better spectacles.

Due to the focusing on various designs of spectacles, on the other hand, all desires of wearers are not satisfied, and since only the designs of the spectacles are developed, moreover, no emphasis is laid on the wearing senses of spectacles and the weight of spectacles. Accordingly, when spectacles are worn on a wearer, some of spectacles are not comfortable and light and have bad durability, so that consumers should pay high purchase cost of their spectacles.

In conventional practices, first, there is provided Korean Utility Model Laid-open Application No. 20-2012-0001477 suggesting a spectacle leg having contractive curved type elastic grooves in spectacles connected to a spectacle frame surrounding lenses and rotatably connected to spectacle legs on both sides thereof, wherein the spectacle leg includes a plurality of curved portions and elastic grooves formed on one side thereof coupled to a locking member so as to allow the folding and unfolding of the spectacle leg to be gently operated, without having any abrasion due to the friction occurring upon the folding and unfolding operations, the curved portions and elastic grooves having a shape of “ [symbol] ” through injection molding and providing an elastic force so that they are contracted or expanded by the opening operation of the spectacle leg, and the elastic grooves having the space formed therein in such a manner as to be elastically moved, without being brought into close contact with the curved portions.

Further, there is provided Korean Utility Model Registration No. 20-0315007 suggesting a spectacle leg made of synthetic resin and metal, wherein the spectacle leg includes a connection rod made of the synthetic resin by means of injection molding and having an assembling hole and a through hole formed on one end thereof, a connection stem coupled to the connection rod through the assembling hole and having a plane portion elongated to a large portion on one end thereof, and a decorative member insertedly attached to the connection rod through the assembling hole and having various materials, shapes and colors.

Furthermore, there is provided Korean Utility Model Registration No. 20-0341082 suggesting a spectacle leg including a leg part and a coated part covered on the end of the leg part, wherein a given groove is formed on the front end of the inner side surface of the coated part and a given silver plate is attached to the given groove through an adhesive.

In case of the above-mentioned conventional practices, the spectacle legs are generally emphasized on their elastic force, through which spectacles come into contact with a wearer's head according to the wearer's head sizes upon the coupling to a spectacle frame. In the conventional practices, however, there is no suggestion for satisfying the uniqueness of customers desiring to have various designs, and undesirably, the spectacle legs are easily damaged or broken.

So as to remove the above-mentioned conventional problems, accordingly, there is a need to develop a new spectacle leg with a light weight, high durability and elasticity, and various designs.

### DISCLOSURE

### Technical Problem

Accordingly, the present invention has been made in view of the above-mentioned problems occurring in the prior art, and it is an object of the present invention to provide a light weight and large width Ultem spectacle leg that is made of an Ultem material and includes wing parts formed on upper and lower side end portions thereof and each having a thickness of 0.8 to 1 mm and a support part formed on the center of the spectacle leg in a longitudinal direction thereof in such a manner as to have a larger thickness than the wing parts, thus reducing the weight of the spectacle leg, increasing the durability of the spectacle leg, and providing two-tone effects when the spectacle leg is worn.

### Technical Solution

To accomplish the above-mentioned object, according to the present invention, there is provided a light weight and large width Ultem spectacle leg that is made of an Ultem material and includes wing parts formed on upper and lower side end portions thereof and each having a thickness of 0.8 to 1 mm and a support part formed on the center of the spectacle leg in a longitudinal direction thereof in such a manner as to have a larger thickness than the wing parts, so that the spectacle leg has a light weight, a large width, and high durability and elasticity, and further, a wearer can feel the spectacle leg is light and visually upgraded, thus satisfying the desires of consumers and optimizing their uniqueness.

### Advantageous Effects

According to the present invention, the light weight and large width Ultem spectacle leg is made of the Ultem material, thus having given elasticity, and the wing parts have the thickness of 0.8 to 1 mm, thus making the weight of the spectacle leg light. Further, the support part is formed on the center of the spectacle leg in a longitudinal direction of the spectacle leg, thus increasing the durability of the spectacle leg and providing the two-tone effects when the spectacle leg is worn. Furthermore, the groove is formed on one side of the support part so as to provide the freedom in colors and designs according to the characteristics of the Ultem material, thus satisfying the desires of consumers and optimizing their uniqueness.

### DESCRIPTION OF DRAWINGS

FIG. 1 is a perspective view showing a light weight and large width Ultem spectacle leg according to the present invention.

FIG. 2 is a side view showing the light weight and large width Ultem spectacle leg according to the present invention.

FIG. 3 is a top sectional view showing the light weight and large width Ultem spectacle leg according to the present invention.

### BEST MODE FOR INVENTION

As modern society has been fast changed, recently, spectacles that provide uniqueness for wearers have been shipped to satisfy the desire of consumers, and further, many studies have been made to develop better spectacles.

Due to focusing on various designs of spectacles, on the other hand, all desires of wearers are not satisfied, and since only the designs of the spectacles are developed, moreover, no emphasis is laid on the wearing senses of spectacles and the weight of spectacles. Accordingly, when spectacles are worn on a wearer, some of spectacles are not comfortable and light and have bad durability, so that consumers should pay high purchase cost of their spectacles.

The present invention relates to a light weight and large width Ultem spectacle leg 10 that is made of an Ultem material and includes wing parts 11 formed on upper and lower side end portions thereof and each having a thickness of 0.8 to 1 mm and a support part 12 formed on the center of the spectacle leg 10 in a longitudinal direction thereof, so that the spectacle leg 10 has a light weight, high durability, and two-tone effects.

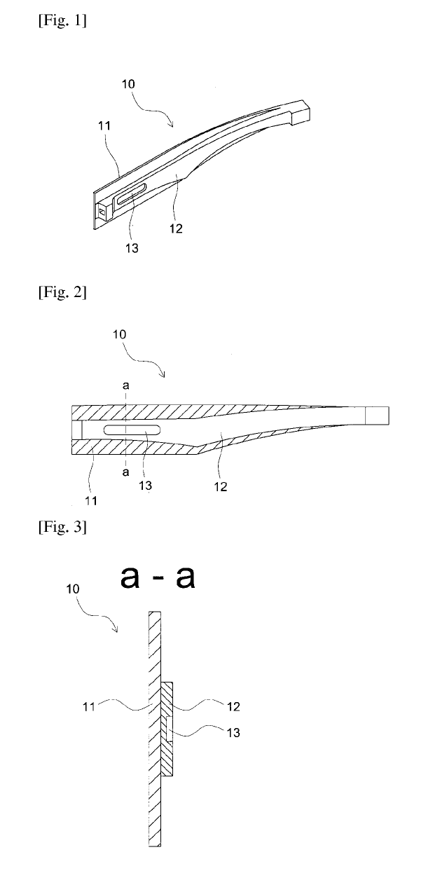

Hereinafter, an explanation on a light weight and large width Ultem spectacle leg according to the present invention will be in detail given with reference to FIGS. 1 to 3.

As shown in FIG. 1, a light weight and large width Ultem spectacle leg 10 according to the present invention, which is hinge-coupled to a spectacle frame, includes wing parts 11 formed on both sides thereof and a support part 12 formed on the center thereof, wherein the wing parts 11 are formed on the upper and lower end portions of the spectacle leg 10 in such a manner as to have a thickness of 0.8 to 1 mm and the support part 12 is formed on the center of the spectacle leg 10 in a longitudinal direction of the spectacle leg 10 in such a manner as to have a larger thickness than the wing parts 11, whereby the whole weight of the spectacle leg 10 is light, the elasticity of the spectacle leg 10 is maintained, and the large width spectacle leg 10 is provided.

In more detail, only the thickness of the spectacle leg is increased in the conventional practice so as to improve the durability of the spectacle leg, thus undesirably needing thick spectacle frames and exhibiting different durability according to the materials of the spectacle legs. So as to remove such conventional problems, accordingly, the spectacle leg 10 according to the present invention is made of an Ultem material and provided with the wing parts 11 formed on the upper and lower sides thereof in such a manner as to have a relatively thin thickness in a range of 0.8 to 1 mm. Advantageously, the wing parts 11 are thin, elastic according to the properties of the Ultem material, and light.

The wing parts 11 are formed long with a large width in the longitudinal direction of the spectacle leg 10 and have the sides having a thickness of 0.8 to 1 mm. Further, the wing parts 11 are bent inwardly according to the properties of the spectacle leg. Furthermore, the wing parts 11 are configured to have core materials fitted to both side ends thereof in such a manner as to be locked on a wearer's ears through the hinge-coupling to a typical spectacle frame. Also, the wing parts 11 are large in width in up and down directions, which is different from the conventional spectacle legs, thus providing high stability when the wearer wears the spectacle leg 10.

TABLE 1
<Average values of durability of wing parts>

| Test Item | Kind | 1 | 2 | 3 |
|---|---|---|---|---|
| Durability | Thickness (mm) | 0.5~0.7 | 0.8~1 | 1.1~1.3 |

| | | | |
|---|---|---|---|
| Result | 8.1 | 8.4 | 8.6 |

As indicated in Table 1, the durability for the spectacle legs having the wing parts 11 having different thicknesses is tested. The average values obtained through a large number of durability tests are indicated in Table 1, and when the wing parts 11 have a thickness of 0.5 to 0.7 mm, the weight of the spectacle leg is light and the durability thereof is 8.1. Further, when the wing parts 11 have a thickness of 0.8 to 1 mm, the weight of the spectacle leg is a little heavy and the durability thereof is 8.4, and when they have a thickness of 1.1 to 1.3 mm, the weight of the spectacle leg is very heavy and the durability thereof is 8.6. As appreciated from Table 1, when the wing parts 11 have a thickness of 0.8 to 1 mm, the weight of the spectacle leg is relatively light and the durability thereof is high, and therefore, it is most desirable that the wing parts 11 have a thickness of 0.8 to 1 mm. In this case, in values from 0 to 10, the value 0 is the lowest value, and the value 10 is the highest value.

TABLE 2
<Average values of elasticity of wing parts>

| Test Item | Find | 1 | 2 | 3 |
|---|---|---|---|---|
| Elasticity | Thickness (mm) | 0.5~0.7 | 0.8~1 | 1.1~1.3 |

| | | | |
|---|---|---|---|
| Result | 9.8 | 9.5 | 9.0 |

As listed in Table 2, further, the elasticity for the spectacle legs having the wing parts 11 having different thicknesses is tested. The average values obtained through a large number of elasticity tests are indicated in Table 2, and when the wing parts 11 have a thickness of 0.5 to 0.7 mm, the elasticity of the spectacle leg is 9.8. Further, when the wing parts 11 have a thickness of 0.8 to 1 mm, the elasticity of the spectacle leg is 9.5, and when they have a thickness of 1.1 to 1.3 mm, the elasticity of the spectacle leg is 9.0. The smaller the thickness of the wing parts 11 is, the higher the elasticity of the spectacle leg is.

As appreciated from Tables 1 and 2, when the wing parts 11 have a thickness of 0.5 to 0.7 mm, the spectacle leg has light weight and good elasticity, but has low durability. Accordingly, if the wing parts 11 have a thickness of 0.8 to 1 mm, the spectacle leg has a little heavy weight and low elasticity, but has high durability. Further, when the wing parts 11 have a thickness of 1.1 to 1.3 mm, the spectacle leg has a very heavy weight and very low elasticity, but has very high durability. According to the average values of the tests in Tables 1 and 2, when the wing parts 11 have a thickness of 0.8 to 1 mm, the weight of the spectacle leg is relatively light, the elasticity thereof is relatively high, and the durability thereof is very high. The test result values of the weights of the wing parts 11 having the different thicknesses in Tables 1 and 2 are absolutely obtained according to the physical laws wherein the smaller the thickness of something is, the higher the elasticity thereof is, and accordingly, they are not indicated additionally therein.

So as to increase the durability of the spectacle leg 10, in this case, the support part 12 is formed on the center of the spectacle leg 10 inside the wing parts 11 in the longitudinal direction of the spectacle leg 10 in such a manner as to have a larger thickness than the wing parts 11, thus supporting the center of the spectacle leg 10. The durability test results of the wing parts 11 formed integrally with the support part 12 are indicated in Table 3.

TABLE 3
<Average values of durability of wing parts
formed integrally with support part>

| Test item | Kind | 1 | 2 | 3 |
|---|---|---|---|---|
| Durability | Thickness (mm) | 0.5~0.7 | 0.8~1 | 1.1~1.3 |
| | of wing parts | | | |

| | | | |
|---|---|---|---|
| Result | 8.9 | 9.3 | 9.5 |

As appreciated from Table 3, the average value of the durability is 8.9 when the support part 12 is further formed in the state where the wing parts 11 have a thickness of 0.5 to 0.7 mm, the average value of the durability is 9.3 when the support part 12 is further formed in the state where the wing parts 11 have a thickness of 0.8 to 1 mm, and the average value of the durability is 9.5 when the support part 12 is further formed in the state where the wing parts 11 have a thickness of 1.1 to 1.3 mm.

As mentioned above, the spectacle leg 10 has the support part 12 formed integrally with the wing parts 11, so that the spectacle leg 10 has higher durability than that having only the wing parts 11 formed on the spectacle leg 10, thus preventing the breakage thereof, while maintaining given elasticity and having a little heavier weight. According to the result values of Tables 1, 2 and 3, however, when the spectacle leg 10 of the present invention has the wing parts 11 having a thickness of 0.8 to 1 mm and the support part 12 formed on the center thereof at the inside of the wing parts 11 in the longitudinal direction thereof, the weight, durability and elasticity of the spectacle leg 10 are all satisfied.

Further, the formation of the support part 12 on the spectacle leg 10 allows the spectacle leg 10 to be two-toned to provide the visual upgrading of the spectacle leg 10. So as to allow the spectacles to be two-toned, in the conventional practice, painting is performed separately on the spectacle leg or the spectacle frame, but according to the present invention, the two-tone effects can be achieved through the characteristics of the Ultem material of the spectacle leg 10.

Further, the support part 12 has a groove 13 having a variety of shapes selectively formed on one side thereof so as to satisfy the rapidly changed desire of consumers. The groove 13 has various polygonal shapes, such as triangular, rectangular, and circular shapes, and otherwise, it may have a pattern formed in the typical spectacle leg. The formation of the groove 13 provides the freedom in colors and designs according to the characteristics of the Ultem material, and according to the present invention, the groove 13 is elongated in the longitudinal direction of the spectacle leg 10 and has a circular shape.

The light weight and large width Ultem spectacle leg 10 according to the present invention is made of the Ultem material, thus having given elasticity, and the wing parts 11 have a thickness of 0.8 to 1 mm, thus making the weight of the spectacle leg 10 light. Further, the support part 12 is formed on the center of the spectacle leg 10 inside the wing parts 11 in the longitudinal direction of the spectacle leg 10, thus increasing the durability of the spectacle leg 10 and providing the two-tone effects when the spectacle leg 10 is worn. Furthermore, the groove 13 is formed on one side of the support part 12 so as to provide the freedom in colors and designs according to the characteristics of the Ultem material, thus satisfying the desires of consumers and optimizing their uniqueness.

1. A light weight and large width Ultem spectacle leg 10 hinge-coupled to a spectacle frame and made of an Ultem material, comprising:
wing parts 11 formed on upper and lower side end portions thereof and each having a thickness of 0.8 to 1 mm; and
a support part 12 formed on the center of the spectacle leg 10 in a longitudinal direction thereof in such a manner as to have a larger thickness than the wing parts 11,
whereby the spectacle leg 10 has a light weight, a large width, and high durability and elasticity.

2. The light weight and large width Ultem spectacle leg according to claim 1, wherein the support part 12 has a groove 13 formed on one side thereof to provide a variety of design shapes.
